(19) United States
(12) Patent Application Publication
(10) Pub. No.: US 2005/0162616 A1
(43) Pub. Date: Jul. 28, 2005

(54) System and method of contrast enhancement in digital projectors

(75) Inventors: Anurag Gupta, Corvallis, OR (US); P. Guy Howard, Junction City, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD CO.

(21) Appl. No.: 10/764,147

(22) Filed: Jan. 23, 2004

(51) Int. Cl. G03B 21/00

(52) U.S. Cl. 353/33

(57) ABSTRACT

A system and method for enhancing contrast in a digital projector is disclosed. The method includes positioning a first optical component, such as a digital micro-mirror device (DMD), and a second optical component, such as a total internal reflection (TIR) prism, along a light path. The first optical component and the second optical component are separated by a gap. The perimeter of the gap is sealed with a sealant. The gap may be evacuated to provide substantially a vacuum in the gap. Alternatively, the gap may be filled with a fluid, such as a liquid or a gel. The fluid may have a refractive index substantially similar to the refractive index of at least one of the optical components.

### BACKGROUND OF THE INVENTION

The present invention relates generally to the field of digital projectors. In particular, the invention relates to methods and systems for enhancing the contrast in digital projectors.

Digital projectors using a telecentric architecture have gained prominence in recent years. Telecentric architecture refers to an arrangement in which the chief rays for all points across an image are collimated. This has the effect of eliminating perspective distortion.

A typical telecentric architecture is illustrated in FIG. 1. A typical telecentric projector arrangement 100 includes a light source portion 110, a projection portion 120 and an image processing portion 130. The light source portion 110 includes a light source and one or more lenses directing the light to the image processing portion 130. The processed image is then directed from the image processing portion 130 through the projection portion 120 to, for example, a screen. The projection portion also includes one or more lenses to direct and/or focus the image onto the screen.

FIG. 2 illustrates the image processing portion 130 in greater detail. The key component of the image processing portion 130 is a digital micro-mirror device (DMD) 140 which processes the light into pixels of the image. DMD's are well known to those skilled in the art and do not require further discussion for purposes of this application. A DMD cover plate 150 is provided on the reflective surface of the DMD 140. A total internal reflection (TIR) prism 160 is provided in close proximity to the DMD 140. The light from the light source portion 110 is reflected from an internal surface of the TIR prism 160 to the DMD 140, which directs the processed image through the TIR prism 160 in a telecentric manner. The DMD cover plate 150 and the TIR prism 160 are separated by a gap 170, which may be of any selected size but is generally small to provide a more compact projector.

One problem with telecentric projectors has been a degradation in the contrast of the projected image due to scattering of light by the collected dust on the surfaces 150a, 160a of the DMD cover plate 150 and the TIR prism 160, respectively. The performance of the projector degrades over time as a result of this dust accumulation. Additional degradation in the contrast occurs due to partial reflection of light from the DMD cover plate surface 150a and the surface 160a of the TIR prism 160, resulting in ghost images.

It is desirable to achieve simple and economical systems and methods for enhancing the contrast of the image in such digital projectors.

### SUMMARY OF THE INVENTION

One embodiment of the invention relates to a method for enhancing contrast in a digital projector. The method includes positioning a first optical component and a second optical component along a light path. The first optical component and the second optical component are separated by a gap. The perimeter of the gap is sealed with a sealant.

It is to be understood that both the foregoing general description and the following detailed description are exemplary and exemplary only, and are not restrictive of the invention as claimed.

### BRIEF DESCRIPTION OF THE DRAWINGS

FIG. 1 illustrates a typical digital projector having a telecentric architecture;

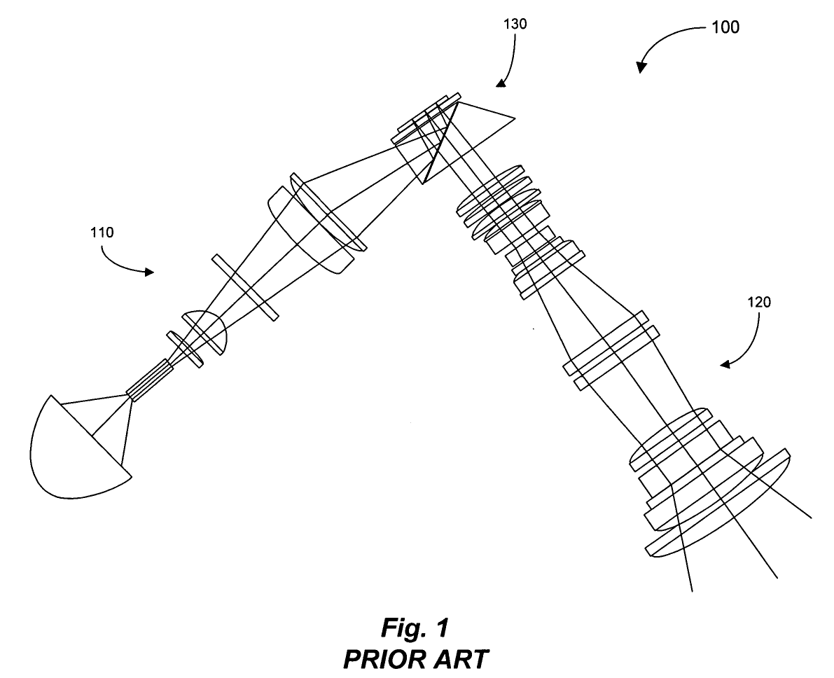

FIG. 2 illustrates the image processing portion of the digital projector of FIG. 1 in greater detail;

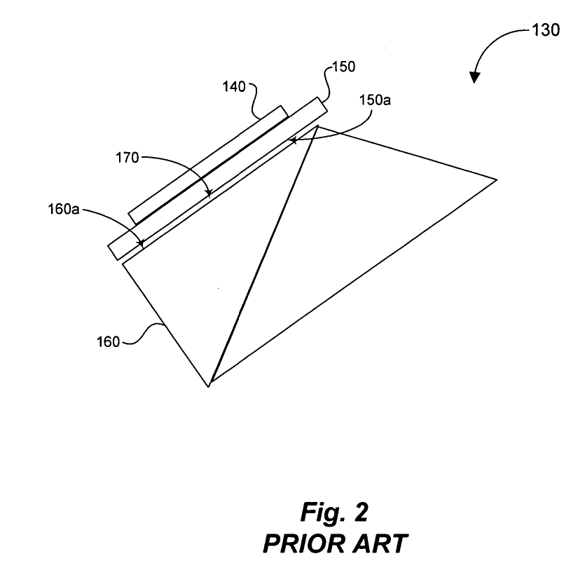

FIG. 3 illustrates a contrast-enhancing system for digital projectors according to an embodiment of the invention; and

FIG. 4 is a flow chart illustrating a method of enhancing contrast according to an embodiment of the invention.

### DETAILED DESCRIPTION OF THE PREFERRED EMBODIMENTS

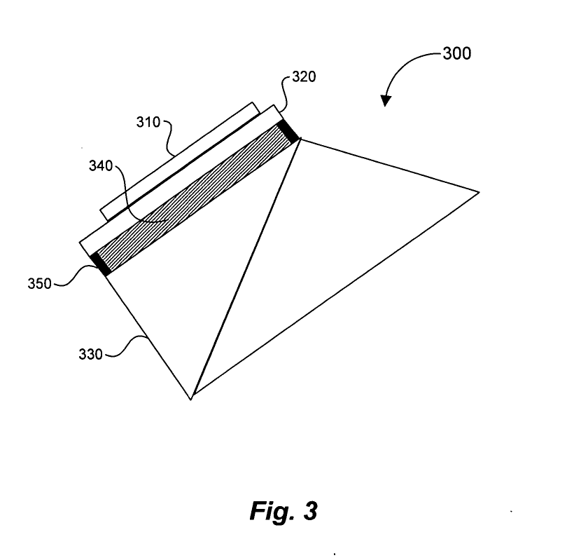

Referring to FIG. 3, a contrast-enhancing system for digital projectors is illustrated. The illustrated embodiment shows a system 300 in a projector having a telecentric architecture, including a DMD 310, a DMD cover plate 320 and a TIR prism 330. The DMD cover plate 320 is preferably made of glass. In one embodiment, the cover plate 320 is made of ZKN7 glass having a refractive index of 1.508. Similarly, the TIR prism 330 is also made of glass, such as BK7 glass having a refractive index of 1.517.

The DMD cover plate 320 and the TIR prism 330 are separated by a gap 340. The gap 340 may be of any size desired for the design of the projector. Typical gap thicknesses can range from a few microns to a few millimeters. In a preferred embodiment, the thickness is about 5 microns.

A sealant 350 is provided along the perimeter of the gap 340 between the DMD cover plate 320 and the TIR prism 330. The sealant can be any one of a number of commercially available sealants that are well known to those skilled in the art. The sealant 350 prevents dust and other pollutants from entering the light path between the DMD cover plate 320 and the TIR prism 330.

The sealant 350 is positioned to create a sealed gap sufficiently large to allow the entire light path to pass therethrough. In this regard, the sealant 350 is preferably positioned substantially along the perimeter of the DMD cover plate 320 and/or the TIR prism 330. In this manner, the gap 340 is made as large as at least one of the optical components through which the light path passes.

In one embodiment, air is allowed to remain in the gap once the sealant is applied to the perimeter. In a preferred embodiment, the gap is evacuated to provide substantially a vacuum having a refractive index of about 1.0.

In other embodiments, the sealed gap 340 may be filled with a liquid, gel, adhesive or other fluid. For example, the gap 340 may be filled with a liquid having a refractive index which substantially matches the refractive index of one of the optical components forming the gap 340. For example, a liquid having a refractive index similar to that of the TIR prism 330, which has a refractive index of 1.517 in one embodiment, may be used to fill the gap 340. Optical liquids having a desired refractive index are commercially available, for example, from Cargille Laboratories, Inc. Optical gels are also available from Cargille Laboratories under the names Optical Gel Codes 0607 and 0608. Optical adhesives having a specific refractive index are commonly available, for example, from Edmund Optics.

By filling the gap with a fluid having a refractive index matching that of the TIR prism 330, reflection of light off the surface of the TIR prism is significantly reduced. Such reflection can cause a substantial degradation in the contrast and image quality. Typical digital projectors counter this reflection by providing a strong anti-reflective (AR) coating on the surface of the TIR prism. Using a fluid which matches the refractive index of the TIR prism eliminates the need for the AR coating, resulting in savings in cost of manufacturing the digital projector.

Using a fluid to fill the gap can also allow the gap to be narrowed significantly. In practice, the fluid may be simply sprayed on one or both surfaces forming the gap. The surfaces are then rubbed against one another to provide a uniform application of the fluid. The sealant may then be applied to the perimeter of the gap. This can result in the gap being a little as 5 microns.

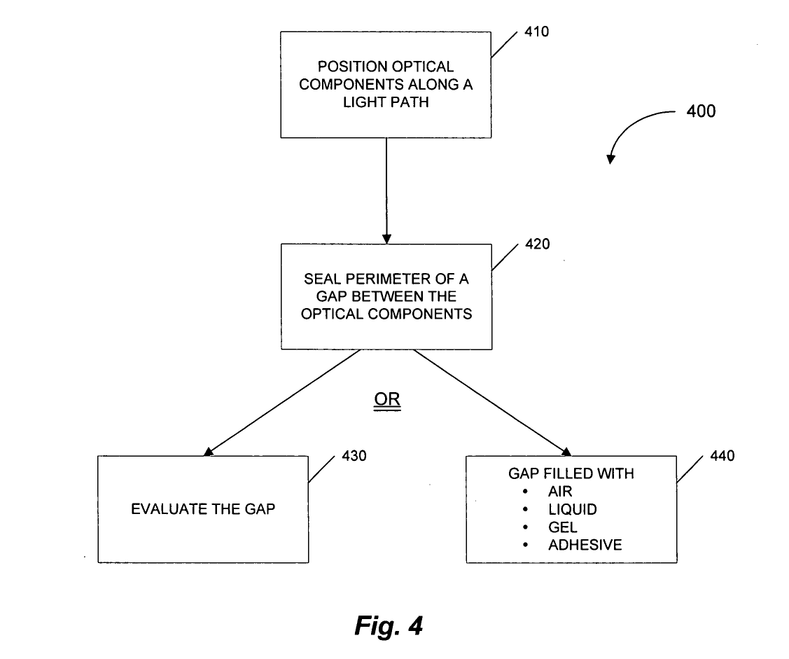

Referring now to FIG. 4, a flow chart illustrating an embodiment of a method for enhancing contrast in a digital projector is described. The method 400 includes positioning optical components along a light path (block 410). As noted above, the optical components may be a DMD cover plate and a TIR prism for digital projectors having a telecentric architecture. The components are positioned so a gap is provided therebetween. The gap may be of any size, but is preferably less than a few millimeters. In one embodiment, the gap may be only five microns.

At block 420, the perimeter of the gap is sealed. The perimeter of the gap is sufficient to allow the entire light path to pass therethrough. The gap may be sealed using any number of means, such as commercially available sealants. The sealing of the gap prevents airflow through the gap, thereby preventing dust and other pollutants from settling on the surfaces of the optical components.

In one embodiment, the sealed gap is evacuated to provide a substantial vacuum within the gap (block 430). Thus, a vacuum with a reflective index of approximately 1.0 is achieved.

In other embodiments (block 440), the gap may be filled with any one of a number of materials. For example, the air in the gap at the time of sealing may be allowed to stay therein. Alternatively, a liquid may be provided in the gap. As discussed above, the liquid may be selected to have a reflective index similar to that of one of the optical components. In still other embodiments, the gap may be filled with a gel or an adhesive, as described above.

The foregoing description of the preferred embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

1. A method for enhancing contrast in a digital projector, comprising:
positioning a first optical component and a second optical component along a light path, said first optical component and said second optical component being separated by a gap;
sealing a perimeter of said gap with a sealant, said sealant being positioned around said light path; and
evacuating said gap to provide substantially a vacuum in said gap.

2-3. (canceled)

4. The method of claim 1, wherein said first optical component is a digital micro-mirror device cover plate and said second optical component is a total internal reflection prism.

5. The method of claim 1, wherein said sealant is positioned substantially along a perimeter of at least one of said first and second optical components.

6-11. (canceled)

12. A system for enhancing contrast in a digital projector, comprising:
a first optical component and a second optical component positioned along a light path and being separated by a gap; and
a sealant adapted to seal said gap substantially along a perimeter of said gap, said sealant being positioned around said light path;
wherein said gap is evacuated to provide substantially a vacuum in said gap.

13-14. (canceled)

15. The system of claim 12, wherein said first optical component is a digital micro-mirror device cover plate and said second optical component is a total internal reflection prism.

16. The system of claim 12, wherein said sealant is positioned along a perimeter of at least one of said first and second optical components.

17-22. (canceled)

23. A system for enhancing contrast in a digital projector, comprising:
a first optical component and a second optical component positioned along a light path and being separated by a gap; and
means for sealing said gap substantially along a perimeter of said gap, said means for sealing being positioned around said light path;
wherein said gap is evacuated to provide substantially a vacuum in said gap.

24. (canceled)

25. A system for enhancing contrast in a digital projector, comprising:
a first optical component and a second optical component positioned along a light path and being separated by a gap; and
means for restricting airflow through said gap, said gap having a substantial vacuum therein.

26. (canceled)

27. A digital projector, comprising:
at least two optical components positioned along a light path;
a gap formed between two of said optical components; and
a sealant adapted to seal said gap substantially along a perimeter of said gap, said sealant being positioned around said light path;
wherein said gap is evacuated to provide substantially a vacuum in said gap.

28-30. (canceled)
